(19) United States
(12) Patent Application Publication
(10) Pub. No.: US 2004/0062974 A1
(43) Pub. Date: Apr. 1, 2004

(54) Separator plate for PEM fuel cell

(76) Inventors: Mahmoud H. Abd Elhamid, Grosse Pointe Woods, MI (US); Richard H. Blunk, Macomb Township, MI (US); Daniel John Lisi, Eastpointe, MI (US); Youssef Morcos Mikhail, Sterling Heights, MI (US)

Correspondence Address: Cary W. Brooks, General Motors Corporation Legal Staff, 300 Renaissance Center, MC 482-C23-B21, PO Box 300, Detroit, MI, 48265-3000, US

(21) Appl. No.: 10/603,684

(22) Filed: Jun. 26, 2003

Related U.S. Application Data
(60) Provisional application No. 60/394,647, filed on Jul. 9, 2002.

(51) Int. Cl. H01M 8/02; H01B 1/24; B29C 43/02

(52) U.S. Cl. 429/34; 252/511; 264/331.11

(57) ABSTRACT

A composite separator plate for use in a fuel cell stack and method of manufacture is provided. The composite separator plate is polymeric and includes expanded graphite dispersed throughout the polymeric material. The expanded graphite provides an electrically conductive pathway through the separator plate. The method includes the step of dispersing by mixing or sprinkling the expanded graphite in the polymeric material and compressing the expanded graphite while compression molding the separator plate.

This application is based on and claims priority in U.S. Provisional Patent Application Serial No. 60/394,647 filed Jul. 9, 2002.

### FIELD OF THE INVENTION

The present invention relates to PEM fuel cells, and more particularly to composite separator plates (e.g. bipolar plates) therefore.

### BACKGROUND OF THE INVENTION

Fuel cells are being developed as a power source for many applications including vehicular applications. One such fuel cell is the proton exchange membrane or PEM fuel cell. PEM fuel cells are well known in the art and include in each cell thereof a membrane electrode assembly or MEA. The MEA is a thin, proton-conductive, polymeric, membrane-electrolyte having an anode electrode face formed on one side thereof and a cathode electrode face formed on the opposite side thereof. In general, the membrane-electrolyte is made from ion exchange resins, and typically comprise a perfluoronated sulfonic acid polymer such as NAFION™ available from the E.I. DuPont de Nemeours & Co. The anode and cathode faces, on the other hand, typically comprise finely divided carbon particles, very finely divided catalytic particles supported on the internal and external surfaces of the carbon particles, and proton conductive particles such as NAFION™ intermingled with the catalytic and carbon particles; or catalytic particles, without carbon, dispersed throughout a polytetrafluorethylene (PTFE) binder.

Multi-cell PEM fuel cells comprise a plurality of the MEAs stacked together in electrical series and separated one from the next by a gas-impermeable, electrically-conductive current collector known as a separator plate or a bipolar plate. Such multi-cell fuel cells are known as fuel cell stacks. The bipolar plate has two working faces, one confronting the anode of one cell and the other confronting the cathode on the next adjacent cell in the stack, and electrically conducts current between the adjacent cells. Current collectors at the ends of the stack contact only the end cells and are known as end plates. The separator plate contains a flow field that distributes the gaseous reactants (e.g. H₂ and O₂/air) over the surfaces of the anode and the cathode. These flow fields generally include a plurality of lands which contact the primary current collector and define therebetween a plurality of flow channels through which the gaseous reactants flow between a supply header and an exhaust header located at opposite ends of the flow channels.

A highly porous (i.e. ca. 60%-80%), electrically-conductive material (e.g. cloth, screen, paper, foam, etc.) known as “diffusion media” is interposed between the current collectors and the MEA and serves (1) to distribute gaseous reactant over the entire face of the electrode, between and under the lands of the current collector, and (2) collects current from the face of the electrode confronting a groove, and conveys it to the adjacent lands that define that groove. One known such diffusion media comprises a graphite paper having a porosity of about 70% by volume, an uncompressed thickness of about 0.17 mm, and is commercially available from the Toray Company under the name Toray 060. Such diffusion media can also comprise fine mesh, noble metal screen and the like as is known in the art.

In an H₂—O₂/air PEM fuel cell environment, the current collectors are in constant contact with mildly acidic solutions (pH 3-5) containing F⁻, SO₄⁻³¹ , SO₃⁻, HSO₄⁻, CO₃⁻⁻, and HCO₃⁻, etc. Moreover, the cathode operates in a highly oxidizing environment, being polarized to a maximum of about +1 V (vs. the normal hydrogen electrode) while being exposed to pressurized air. Finally, the anode is constantly exposed to hydrogen. Hence, the current collectors must be resistant to a hostile environment in the fuel cell.

Expanded graphite has been used before in bipolar plates (Ballard uses expanded graphite plates in their current fuel cell stacks and SGL carbon has done lots of work with EG plates). However, this process starts with sheets of EG and impregnate polymeric resin into these sheets to reduce gas permeation. The plate has between 80 to 90% graphite and is difficult to manufacture.

Accordingly, current collectors have heretofore been either (1) machined from pieces of graphite, (2) molded from polymer composite materials comprising about 50% to about 90% by volume electrically-conductive filler (e.g. graphite particles or filaments) dispersed throughout a polymeric matrix (thermoplastic or thermoset), or (3) fabricated from metals coated with polymer composite materials containing about 30% to about 40% by volume conductive particles. In this later regard, see U.S. Pat. No. 6,372,376 to Fronk et al issued Apr. 16, 2002 which (1) is assigned to the assignee of this invention, (2) is incorporated herein by reference, and (3) discloses current collectors made from metal sheets coated with a corrosion-resistant, electrically conductive layer comprising a plurality of electrically conductive, corrosion-proof (i.e. oxidation-resistant and acid resistant) filler particles dispersed throughout a matrix of an acid resistant, water insoluble, oxidation resistant polymer that binds the particles together and to the surface of the metal sheet. Fronk et al type composite coatings will preferably have a resistivity no greater than about 50 mohm-cm and a thickness between about 5 microns and 75 microns depending on the composition, resistivity and integrity of the coating. The thinner coatings are preferred to achieve lower IR drop through the fuel cell stack, whereas the thicker coatings are preferred for enhanced corrosion protective.

Another approach to using metal plates has been to coat lightweight metal current collectors with a layer of metal or metal compound, which is both electrically conductive and corrosion resistant to thereby protect the underlying metal. See for example, Li et al RE 37,284E, issued Jul. 17, 2001, which is assigned to the assignee of the present invention, and discloses a lightweight metal core, a stainless steel passivating layer atop the core, and a layer of titanium nitride (TiN) atop the stainless steel layer.

Conventionally, a separator plate is formed of a suitable metal alloy such as stainless steel or aluminum protected with a corrosion resistant, conductive coating for enhancing the transfer of thermal and electrical energy. Such metal plates require two stamping or etching processes to form the flow fields and either a bonding or brazing process to fabricate a cooled plate assembly which adds cost and complexity to the design. In addition, the durability of the metal plate in the corrosive fuel cell environment and the possibility of coolant leakage remains a concern.

These drawbacks have led to the development of composite separator plates. In this regard, recent efforts in development of a composite separator plate have been directed to materials having adequate electrical and thermal conductivity. Material suppliers have developed high carbon loading composite plates consisting of graphite powder in the range of 50% to 90% by volume in a polymer matrix to achieve the requisite conductivity targets. Separator plates of this type survive the corrosive fuel cell environment and, for the most part, meet cost and conductivity targets. However, due to the high graphite loading and the high specific gravity of graphite, these plates are inherently brittle and dense which yield less than desirable volumetric and gravimetric stack power densities. One such currently available bipolar plate is available as the BMC plate from Bulk Molding Compound, Inc. of West Chicago, Ill.

Alternatively, discrete conductive fibers have been used in composite plates in an attempt to reduce the carbon loading and to increase plate toughness see co pending U.S. patent application, Blunk, et. al., Ser. No. 09/871,189, filed May 31, 2001 which is assigned to the assignee of this invention, and is incorporated herein by reference. Fibrous materials are typically ten to one thousand times more conductive in the axial direction as compared to conductive powders. Consequently, a polymeric separator plate having a conductive fibrous material disposed therein would increase the electrical conductivity of the plate without having a relatively high concentration of carbon loading which may lead to brittleness. However, to achieve these benefits, the fibrous materials must be properly oriented in a through plane direction. Moreover, a polymeric separator plate having a continuous conductive fibrous members extending therethrough in a through plane orientation would greatly enhance the transfer of electrical energy through the separator plate; however, it is somewhat more complicated to manufacture. See U.S. patent application Ser. No. 10/074,913 to Lisi, et. al., filed Feb. 11, 2002 which is assigned to the assignee of the present invention and is incorporated herein by reference.

Efforts have been made to reduce the fuel cell stack mass and volume by using thinner plates. Unfortunately, the brittle nature of these plates frequently results in cracking and breaking, particularly during part demolding, during adhesive bonding, and during stack assembly operations. As such, a separator plate having a relatively low carbon concentration and relatively high-polymer concentration is desirable to reduce the brittleness of the separator plate and to meet fuel cell stack mass and volume targets. Unfortunately, heretofore at low carbon concentrations, it is extremely difficult to meet the desired electrical and thermal conductivity targets.

Thus, there is a desire to provide a composite fuel cell separator plate and a method of manufacture that overcomes the inherent problems associated with high carbon loaded plates, plates loaded with conductive fibers and the difficulties associated therewith. Therefore, it is desirable to provide a fuel cell separator or bipolar plate formed of a composite material having high electrical and thermal conductivity at low conductive filler loadings in order to mold thin and less brittle plates and, in turn, meet fuel cell mass and volume targets.

### SUMMARY OF THE INVENTION

According to the present invention there is provided a composite separator plate for use in a fuel cell stack of the type having a first surface and a second surface opposite said first surface. The composite separator plate comprising a polymeric material and expanded graphite dispersed in said polymeric material.

According to the present invention there is provided a composite separator plate for use in a fuel cell stack of the type having a first surface and a second surface opposite said first surface. The composite separator plate comprising a polymeric material and a compressible conductive material dispersed in said polymeric material.

According to the present invention there is also provided a method of manufacturing a composite separator plate for use in a fuel cell stack. The method comprises the steps of preparing expanded graphite into particles. The expanded graphite is dispersed into a polymeric resin. Then, the resin and graphite particles are compression molded to form the separator plate.

In one method, the expanded graphite is dispersed into the polymeric resin by mixing it in to the polymeric resin. In an alternate method, the expanded graphite is sprinkled into the polymeric resin using an SMC-like process.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic exploded illustration of a PEM fuel stack;

FIG. 2 is an exploded, isometric view of a bipolar plate useful with PEM fuel cell stacks like that illustrated in FIG. 1;

FIG. 3 is an enlarged sectioned view of a portion of a fuel cell stack;

FIG. 4 is an enlarged sectional view of a portion of a bipolar plate according to one embodiment of the present invention, prior to compression;

FIG. 5 is an enlarged sectional view of a portion of a bipolar plate according to one embodiment of the present invention;

FIG. 6 is an enlarged sectional view of a portion of a bipolar plate according to an alternate embodiment of the present invention;

FIG. 7 is a graph showing the material toughness of the composite materials according to the present invention;

FIG. 8 is a graph showing the area resistance of composite materials according to the present invention;

FIG. 9 is a graph showing the area resistance of alternate composite materials according to the present invention;

FIG. 10 is a graph showing the material toughness of composite material according to alternate embodiments of the present invention;

FIG. 11 is a graph showing the area resistance of composite material according to alternate embodiments of the present invention; and

FIG. 12 is a table showing the effect of expanded graphite concentration on the area resistance.

### DETAILED DESCRIPTION OF THE PREFERRED EMBODIMENTS

The following description of the preferred embodiment(s) is merely exemplary in nature and is in no way intended to limit the invention, its application, or uses.

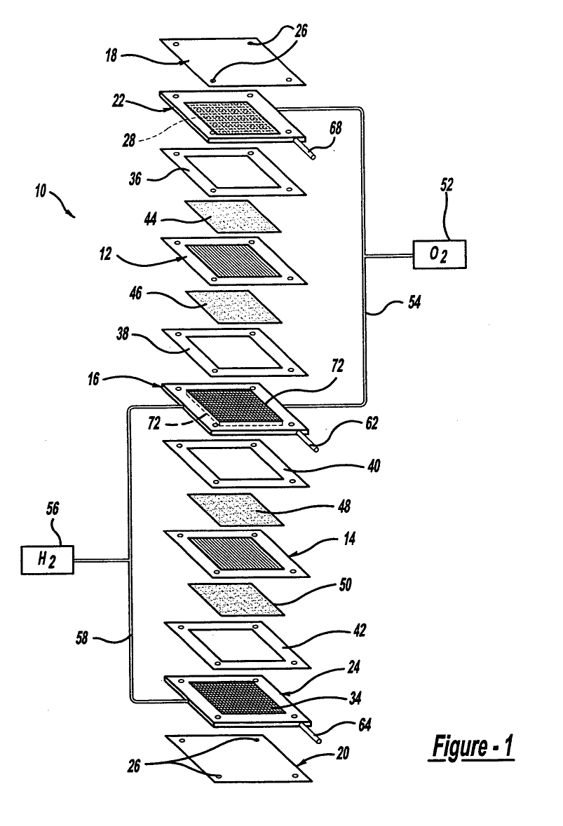

A two cell, bipolar PEM fuel cell stack is generally shown at 10 in FIG. 1. The fuel cell stack 10 includes a pair of membrane-electrode-assemblies (MEAs) generally indicated at 12 and 14. The MEAs are separated from each other by an electrically conductive, liquid-cooled, bipolar plate, generally indicated at 16. The separator plate 16 is also known as a bipolar plate 16. The MEAs 12 and 14, and bipolar plate 16, are stacked together between stainless steel clamping plates generally indicated at 18 and 20 and current collector end plates, generally indicated at 22 and 24. The clamping plates 18 and 20 apply a compressive force to the stack 10 by means of bolts (not shown) that pass through openings 26 at the corners of the clamping plates 18, 20. The end plates 22 and 24, as well as both working faces of the bipolar plate 16, contain a plurality of grooves or channels 28, 34 and 72. The grooves 28 and 34 are on the end plates 22 and 24 respectively, and the grooves 72 are on both faces of the bipolar plate 16. The grooves 28, 34 and 72 are for distributing fuel and oxidant gases (i.e., H₂ & O₂) to the MEAs 12 and 14.

Nonconductive gaskets 36, 38, 40, and 42 provide seals and electrical insulation between the several components of the fuel cell stack. Gas permeable carbon/graphite diffusion media 44, 46, 48 and 50 press up against the electrode faces of the MEAs 12 and 14. The end plates 22 and 24 press up against the carbon/graphite diffusion media 44 and 50 respectively, while the bipolar plate 16 presses up against the carbon/graphite media 46 on the anode face of MEA 12, and against carbon/graphite media 48 on the cathode face of MEA 14.

Oxygen is supplied to the cathode side of the fuel cell stack from storage tank 52 via appropriate supply plumbing 54, while hydrogen is supplied to the anode side of the fuel cell from storage tank 56, via appropriate supply plumbing 58. Alternatively, air may be supplied to the cathode side from the ambient, and hydrogen to the anode from a methanol or gasoline reformer, or the like. Exhaust plumbing (not shown) for both the H₂ and O₂/air sides of the MEAs will also be provided. Additional plumbing 60, 62 and 64 is provided for supplying liquid coolant to the bipolar plate 16 and end plates 22 and 24. Appropriate plumbing for exhausting coolant from the plate 16 and end plates 22 and 24 is also provided, but not shown.

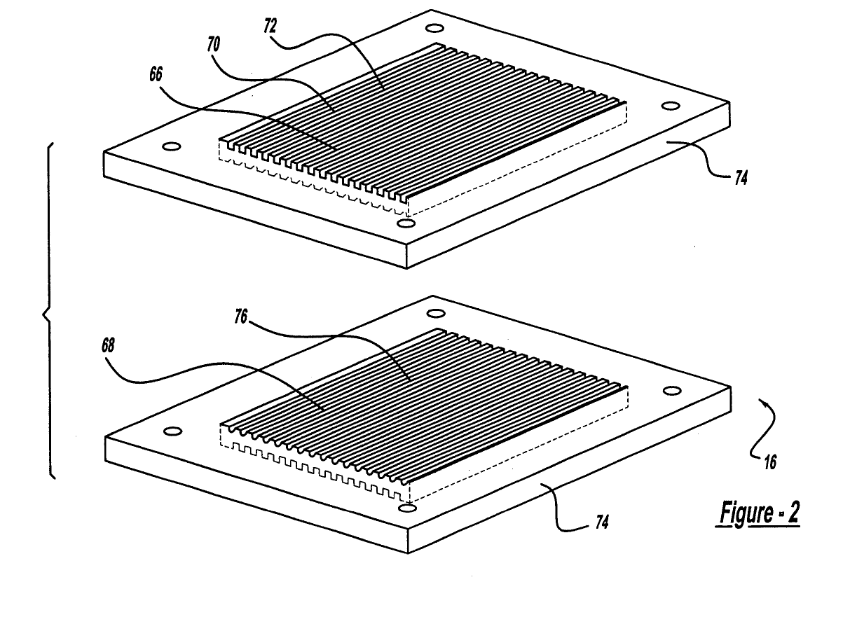

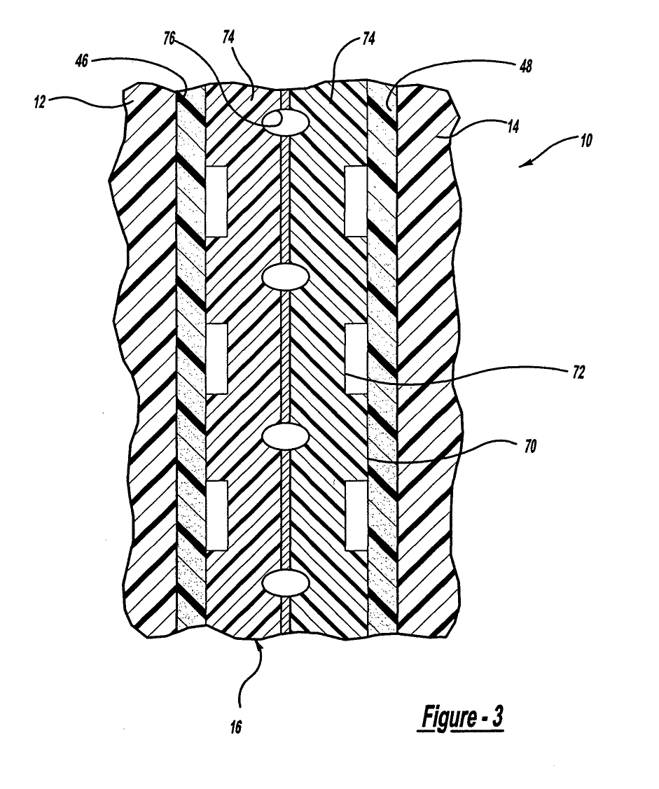

FIG. 2 shows an isometric, schematic view of the bipolar plate 16 of FIG. 1. The bipolar plate 16 actually comprises two similar plate halves 74 secured together. Each plate half is preferably identical, and the two plate halves 74 are secured together such as by the use of a suitable adhesive or brazement. As can be seen in FIGS. 2 and 3, each plate half 74 includes a first surface 66 and a second surface 68. The first surface 66 engages the carbon graphite media 46 and 48. The first surface 66 includes a plurality of lands 70 which define a plurality of grooves 72 therebetween known as a “flow field” through which the fuel cell's reactant gases (i.e., H₂ or O₂) flow in a tortuous path from the first surface 66 of the bipolar plate half 74 to the second surface 68 thereof. When the fuel cell 10 is fully assembled, the lands 70 press against the carbon/graphite media 46 and 48, which, in turn, press against the MEAs 12, and 14 respectively. FIG. 2 depicts the arrays of lands 70 and grooves 72 in greatly exaggerated size. It will be appreciated that the plate 16 can take any configuration.

The second surface 68 of the plate halves include a plurality of channels 76 in the area opposite the land 70. This is best seen in FIG. 3. The channels 76 of opposite plate halves 74 align when the plate halves 74 are secured to provide coolant flow conduits through the bipolar plate 16. As shown in FIG. 3, a coolant channel 76 preferably underlies each land 70. The shape of the lands 70 defines the size, shape and configuration of the flow fields, which may be altered to achieve desired flow of the gaseous reactants. As presently illustrated, the flow fields are configured as having parallel grooves 72 and lands 70.

While bipolar plate halves 74 are shown, it will be appreciated that the bipolar plate 16 may be formed as a single plate. That is, the bipolar plate may be integrally formed having the lands 70 extending from each outer surface thereof and having the cooling channels 76 formed therein.

Each bipolar plate half 74 comprises a composite material. The composite material preferably comprises a polymeric material having relatively high strength, suitable thermal and electrical conductive properties and low permeation with respect to coolant fluid and reactant gases. The composite material further comprises a compressible and conductive additive.

The polymeric material is either a thermoset or a thermoplastic polymer. Preferably, the polymeric material is selected from the group consisting of epoxy, polyvinyl ester, polyester, polypropylene, and polyvinylidene fluoride (PVDF). While the preferred polymeric materials are set forth above, it will be appreciated that any suitable polymeric material may be used within the context of the present invention. It will further be appreciated that the polymeric material may also include cross-linking initiators, such as for example, benzoyl peroxide, at various concentrations, depending on the cure cycle time desired. The polymeric material may also include hardeners, such as for example, benzyldimethylamine, which is particularly useful when utilizing epoxy as the polymeric material. Further, suitable curing agents may be used. One such curing agent is Methyl TetraHydroPhthalic Anhydride (MTHPA), which is particularly useful when utilizing epoxy as the polymeric material.

The thermal and electrical conductivity can be enhanced by loading the polymeric material with a compressible conductive material. The preferred compressible material is expanded graphite. Expanded graphite is made by the exfoliation of the graphitic planes of natural or synthetic graphite. Expanded graphite can be compacted and made into sheets of various thicknesses. Expanded graphite is also porous. Such sheets are commercially available from SGL Carbon Group and are used primarily as gasketing materials. It is preferred that the sheets used are between about 3 mm and 13 mm in thickness. By using such porous and compressible sheets, further compaction of the expanded graphite can be achieved and the polymeric resin can easily penetrate into the porous structure for enhanced adhesion and gas impermeability. The area weight of such sheets is between about 1000 and 4000 g/m². It will be appreciated, however, that other thickness sheets and sheets of different area weight can be used within the scope of the present invention.

The expanded graphite sheets are broken down either manually or automatically into charge sizes of about 1 inch by 1 inch. The charges are then further broken down to an appropriate particle size using a suitable grinding apparatus, such as a mill or mixer. The preferable particle size of the expanded graphite added to the polymeric material is between about 0.4 and 3 mm. Preferably, the particle sizes are greater than about 10% of the final plate thickness. Mixing or milling times of the charges of between 10 seconds and 3 minutes have been found to result in the appropriate particle size. Longer milling times will result in expanded graphite particles of relatively smaller size.

It is preferred that the expanded graphite comprise between about 10% and about 50% by volume of the plate material. It is further preferred that the expanded graphite comprise between about 20% and 35% by volume of the plate material. When lower expanded graphite loading is used, it is preferred to use relatively larger expanded graphite particle sizes, preferably between 1 and 3 mm.

In order to prepare the composite material, the appropriate resin is selected. Cross-linking initiators and hardeners may be added. The expanded graphite particles are prepared in accordance with the procedure set forth above and then screened to the preferred size distribution using an appropriate mesh and mixed into the resin using conventional mixing equipment such as Brabenders, twin-screw extruders and blenders. Once the expanded graphite is dispersed into the resin by mixing, the composite material is compression molded at appropriate pressures and cure times into the desired plate configuration. While compression molding has been disclosed, it will be appreciated that any suitable molding or composite forming technique may be used in accordance with the present invention.

Alternatively, the expanded graphite particles are prepared in accordance with the procedure set forth above and then screened to the preferred size distribution using an appropriate mesh and dispersed into the liquid polymeric resin by sprinkling it therein using a sheet molding compound (SMC)-like process, preferably using a “B-stage” resin system. Once the expanded graphite is dispersed into the resin by being sprinkled into the resin, the composite material is compression molded at appropriate pressures and cure times into the desired plate configuration. Sprinkling is intended to refer to any process that places the expanded graphite into the resin throughout the resin without the need for further mixing to distribute the expanded graphite. This can include, but is not limited to, sprinkling or dropping the expanded graphite from a position above the resin. Use of this method allows for the expanded graphite plate material to be placed in the compression mold more uniformly. Further use of this method allows relatively larger expanded graphite particle sizes to be more easily dispersed into the resin.

In some instances it may be desirable to remove a polymeric skin that may form over the surfaces 66, 68 of the plate during the molding process. This skin can be removed by any suitable process, such as, for example sanding. The removal of this skin will result in a lower contact resistance between the first surface 66 and the adjacent carbon graphite media 46, 48.

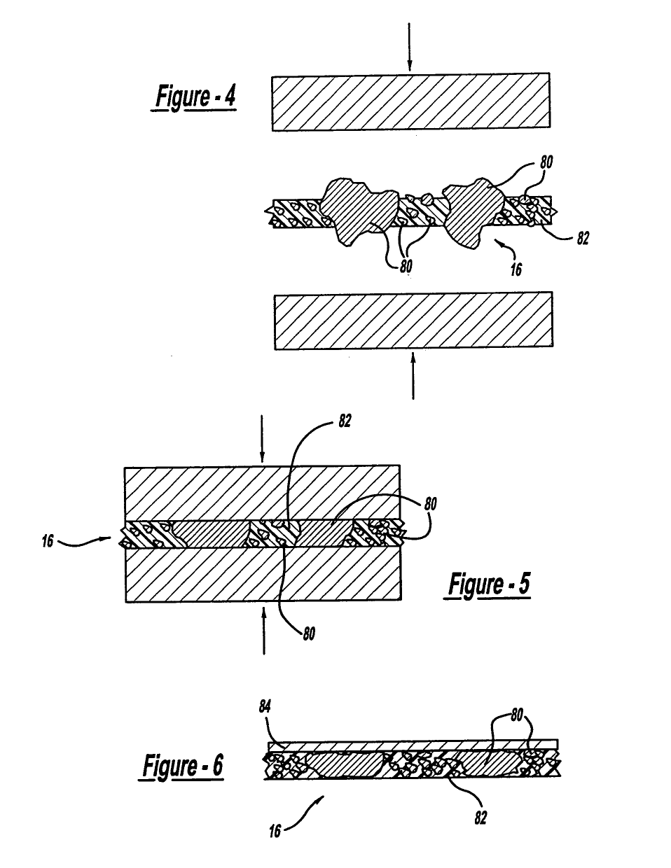

FIG. 4 is a schematic representation of the composite material before the compression molding of the plate 16. As is shown, the expanded graphite particles 80 are dispersed as by mixing or sprinkling in the resin 82. Some of the larger graphite particles 80 may extend out of the resin 82. FIG. 5 is a schematic representation of the composite material after the compression molding of the bipolar plate 16. As can be seen, the graphite particles 80, and particularly those extending out of the resin, are compressed to the thickness of the plate 16. At least some of the graphite particles 80 may extend over the entire thickness of the plate 16. This is beneficial in that a direct and continuous flow path of electrons through the expanded graphite particles 80 is provided, resulting in a relatively lower bulk resistance of the bipolar plate 16. The smaller expanded graphite particles 80 may contact one another to form a flow path for electrons through the thickness of the plate 16. The use of expanded graphite particles 80 results in the achievement of relatively low bulk resistance of the plate at lower levels of graphite loading in the plate 16. Thus, the physical properties of the plate can be tailored using relatively higher polymer concentrations than were previously available.

It will also be appreciated that various fillers may be added to the polymeric resin to tailor the physical properties of the plate 16. The additives can be used to impart strength, toughness, ductility or other physical properties to the plate 16. Many types of additives can be used within the scope of the present invention, including, but not necessarily limited to, glass fibers, metal fibers, cotton flock, polyacrylonitrile (PAN) based fibers milled or chopped. Polymeric and metallic mesh may also be used. If mesh is used, mesh openings greater than 1.5 mm are preferred so that conductivity of the plate is not adversely affected. The volume of the additives is dependent on the final properties of the plate 16 desired. When using carbon fibers, it is desirable not to exceed a total carbon content of 50% by volume.

As best seen in FIG. 6, a conductive tie layer 84 may be placed over the outer surfaces 66 of the plate halves 74, as described in U.S. patent application Ser. No. 09/997,190 to Blunk, et. al., filed Jan. 20, 2001 which is assigned to the assignee of the present invention and incorporated herein by reference. The conductive tie layer is an electrically conductive layer used to help reduce the contact resistance between the first surfaces 66 and the adjacent carbon graphite media 46, 48. Any suitable material may be used for the conductive tie layer 84. Preferred materials for the tie layer 84 include gold, silver, platinum, carbon, palladium, rhodium and ruthenium. The conductive tie layer can be deposited on the first surface 66 by any suitable technique. One suitable technique is the use of vapor deposition of the tie layer 84.

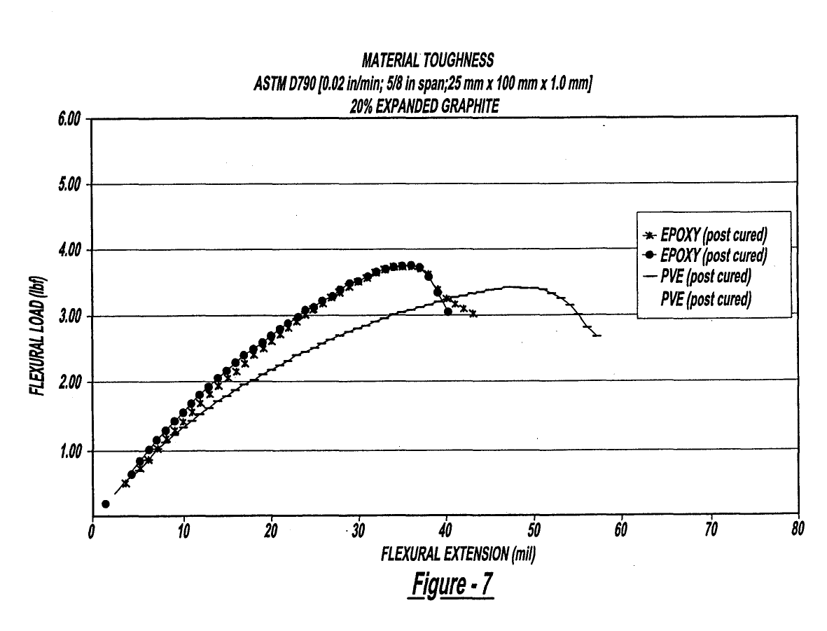

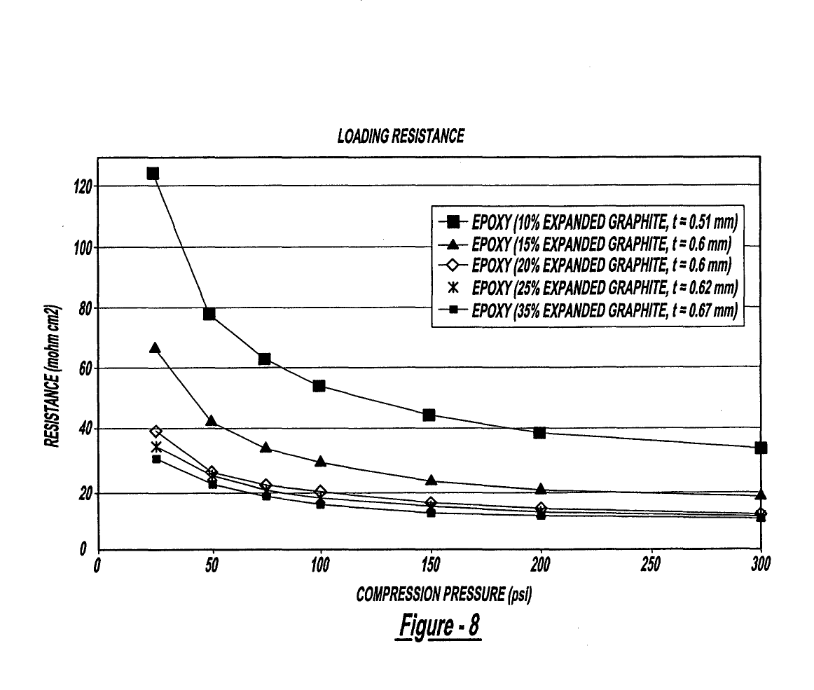

Testing of various plate compositions were performed. The results of the tests are set forth in FIGS. 7-12. In FIGS. 7 and 9 through 11, PVE refers to 75% by volume Ashland polyvinyl ester resin Q6055 with 4% BPO by weight. The cure is 15 minutes at 380° F. (Carver Temp.). The PVE samples were post cured for 60 minutes at 150° C. Epoxy refers to 75% by volume 383 Dow epoxy with MTHPA curing agent and BDMA hardener. The epoxy samples were cured for 20 minutes at 300° F. (Carver Temp.).

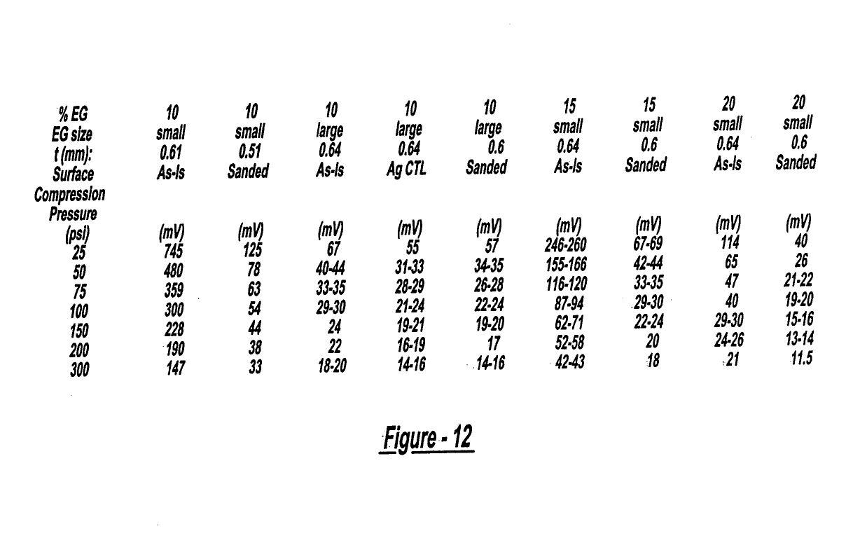

In FIGS. 8 and 12, the epoxy tested comprises Dow Chemical epoxy resin (100 parts by weight), Lonza MTHPA curing agent (80 parts by weight) and BDMA hardener (2 parts by weight). The expanded graphite sheet was obtained from SGL Carbon Group and had a thickness of about 13 mm. This sheet was broken down to about 1 in. by 1 in. charges. Some of the expanded graphite was broken down in a blender for about 3 minutes, resulting in relatively small expanded graphite particles (less than about 1 mm). Some of the expanded graphite was broken down in a blender for about 10 seconds, resulting in relatively larger expanded graphite particles (greater than about 1 mm). The expanded graphite particles were then hand mixed into the epoxy. The mixture was cured at 300° F. (Carver Platen Temperature) for about 15 minutes at 22 tons in 0.5 mm shims.

Separator plates 16 made in accordance with the present invention have a relatively higher polymer content than was previously available. Plates made in accordance with the present invention exhibit low rates of hydrogen permeation. The hydrogen permeation is less than 0.01 mamp/cm² at 25 psig, 80° C. and 0.5 mm). This low permeation suggests that the plates can be made thinner than was previously possible. Corrosion testing data for a simulated cathode-side fuel cell environment at 80° C. and a potential of +0.6V vs. Ag/AgCl electrode exhibited no significant anodic current (about 50 nA/cm²). Further, the plates exhibited low water uptake (<1% for 1 month at 90° C.). The material also exhibited relatively low viscosity, resulting in low pressure drops for ease of manufacturing.

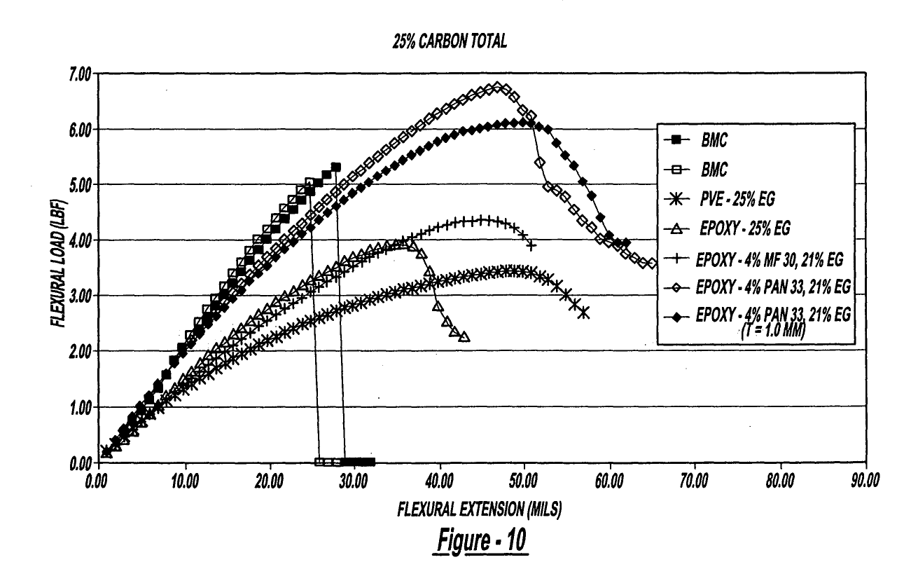

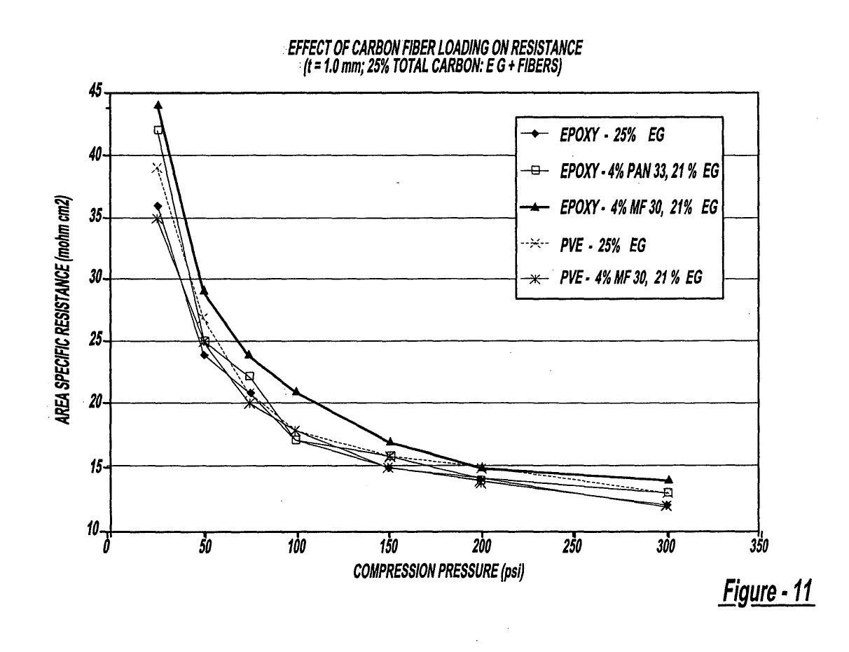

Material toughness tests were conducted. The results of the tests are shown in FIGS. 7 and 10. FIG. 7 shows the results utilizing epoxy and PVE resins and 20% expanded graphite by volume. FIG. 10 shows the effect of the use of PAN based carbon fibers (milled or chopped) on the material toughness. Further, FIG. 10 shows the results compared with BMC bipolar plate material. A standard 3-point flex test pursuant to ASTM D790 was performed. The material exhibited good ductility/toughness when compared to a high-carbon loaded BMC material. The results suggest that plates made in accordance with the present invention would be less brittle than those previously available and less likely to result in scrap. In addition, because of the higher polymer concentration with the present invention, the data clearly indicate that the physical/mechanical properties of the plates can be tailored more easily.

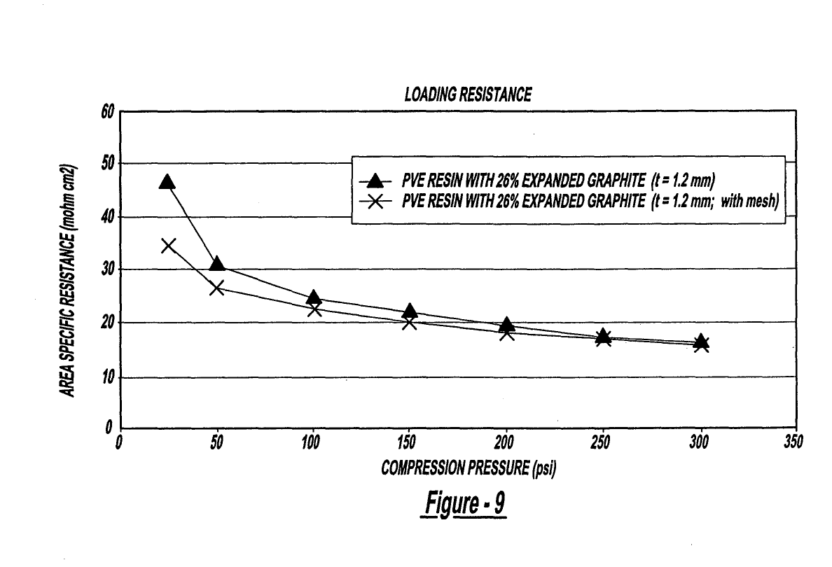

The effect of expanded graphite loading on the area specific resistance of the composite materials made in accordance with the present invention was also tested. FIGS. 8, 9 and 11 each contain the results of the testing data. FIG. 8 shows the results of the tests using a composite formed of epoxy having the expanded graphite loadings shown. FIG. 9 shows the results of the tests using a composite formed of PVE and an expanded graphite loading of about 26 percent. FIG. 11 shows the effect of adding PAN based carbon fibers (milled or chopped) on the resistance.

The text fixture included two suitable electrodes. Appropriate diffusion media was placed over the electrodes and the test materials were placed between the diffusion media. A compressive force was applied to the fixture. The resultant area resistance was measured at the diffusion media on both sides of the test composite separator plate. The results show that each sample has an area specific resistance less than 40 milliohms·cm² at compression pressures less than or equal to 200 psi and greater than 25 psi. The area specific resistance is less than 20 milliohms·cm² at compression pressures greater than or equal to 200 psi.

FIG. 12 shows the effect of expanded graphite concentration on the area resistance. In FIG. 12, the denotation As-is refers to the surface of the separator plate and indicates the surface is as it comes out of the mold. It is not sanded. The denotation sanded refers to sanding the surface of the separator plate. The denotation Ag CTL refers to the deposition of a silver conductive tie layer on the surface of the separator plate.

As is apparent from the test data, one and two-piece bipolar separator plates can be made using the material described above. Such separator plates can be made relative thin, less than 2 mm. They are light in weight, having a density of less than 1.4 g/cc. Such plates also have good thermal and electric conductivity. The plates are tough and can result in reduced scrap relative to currently existing plates, particularly during the demolding, packaging, bonding and stacking operations.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A composite separator plate for use in a fuel cell stack of the type having a first surface and a second surface opposite said first surface, the composite separator plate comprising a polymeric material and expanded graphite dispersed in said polymeric material.

2. A composite separator plate as set forth in claim 1 wherein said expanded graphite comprises between about 10% and about 50% by volume.

3. A composite separator plate as set forth in claim 2 wherein said expanded graphite comprises between about 20% and 35% by volume.

4. A composite separator plate as set forth in claim 1 wherein said expanded graphite is in particle sizes of between about 0.4 and 3.0 millimeters.

5. A composite separator plate as set forth in claim 1 wherein said expanded graphite is in particle sizes of greater than 10 percent of the final plate thickness.

6. A composite separator plate as set forth in claim 1 wherein at least some of said expanded graphite extends from said first surface to said second surface.

7. A composite separator plate as set forth in claim 1 wherein said polymeric material is selected from the group consisting of thermoset and thermoplastic polymers.

8. A composite separator plate as set forth in claim 7 wherein said polymeric material is selected from the group consisting of: epoxy, polyvinyl ester, polyester, polypropylene, and polyvinylidene fluoride.

9. A composite separator plate as set forth in claim 1 wherein said expanded graphite is compressible.

10. A composite separator plate as set forth in claim 1 wherein said expanded graphite is porous.

11. A composite separator plate as set forth in claim 1 wherein said plate further comprises a filler material dispersed in said polymeric material.

12. A composite separator plate as set forth in claim 11 wherein said filler material is selected from the group consisting of glass fibers, metal fibers, cotton flock, polyacrylonitrile (PAN) based carbon fibers, and polymeric and metallic mesh.

13. A composite separator plate as set forth in claim 1 wherein said plate has a hydrogen permeation of less than 0.01 mamp/cm² at 25 psig, 80° C. and 0.5 mm).

14. A composite separator plate as set forth in claim 1 wherein said composite separator plate includes a layer of conductive material disposed over said first surface, said layer of conductive material in contact with said expanded graphite.

15. A composite separator plate as set forth in claim 14 wherein said conductive material is selected from the group consisting of gold, silver, platinum, carbon, palladium, rhodium and ruthenium.

16. A composite separator plate as set forth in claim 1 wherein said plate has an area specific resistance less than 40 milliohms·cm² at compression pressures less than or equal to 200 psi and greater than 25 psi.

17. A composite separator plate as set forth in claim 16 wherein said plate has an area specific resistance less than 20 milliohms·cm² at compression pressures greater than or equal to 200 psi.

18. A composite separator plate for use in a fuel cell stack of the type having a first surface and a second surface opposite said first surface, the composite separator plate comprising a polymeric material and a compressible conductive material dispersed in said polymeric material.

19. A composite separator plate as set forth in claim 18 wherein said compressible material comprises between about 10% and about 50% by volume.

20. A composite separator plate as set forth in claim 19 wherein said compressible material comprises between about 20% and 35% by volume.

21. A composite separator plate as set forth in claim 19 wherein said compressible material comprises expanded graphite.

22. A composite separator plate as set forth in claim 21 wherein said expanded graphite is in particle sizes of between about 0.4 and 3.0 millimeters.

23. A composite separator plate as set forth in claim 18 wherein said compressible material is in particle sizes greater than 10% of the final plate thickness.

24. A composite separator plate as set forth in claim 18 wherein at least some of said compressible material extends from said first surface to said second surface.

25. A composite separator plate as set forth in claim 18 wherein said polymeric material is selected from the group consisting of thermoset and thermoplastic polymers.

26. A composite separator plate as set forth in claim 25 wherein said polymeric material is selected from the group consisting of: epoxy, polyvinyl ester, polyester, polypropylene, and polyvinylidene fluoride.

27. A composite separator plate as set forth in claim 18 wherein said plate further comprises a filler material dispersed in said polymeric material.

28. A composite separator plate as set forth in claim 27 wherein said filler material is selected from the group consisting of glass fibers, metal fibers, cotton flock, polyacrylonitrile (PAN) bassed carbon fibers, and polymeric and metallic mesh.

29. A composite separator plate as set forth in claim 18 wherein said plate has a hydrogen permeation of less than 0.01 mamp/cm² at 25 psig, 80° C. and 0.5 mm)

30. A composite separator plate as set forth in claim 18 wherein said composite separator plate includes a layer of conductive material disposed over said first surface, said layer of conductive material in contact with said expanded graphite.

31. A composite separator plate as set forth in claim 30 wherein said conductive material is selected from the group consisting of gold, silver, platinum, carbon, palladium, rhodium and ruthenium.

32. A composite separator plate as set forth in claim 18 wherein said plate has an area specific resistance less than 40 milliohms·cm² at compression pressures less than or equal to 200 psi and greater than 25 psi.

33. A composite separator plate as set forth in claim 32 wherein said plate has an area specific resistance less than 20 milliohms·cm² at compression pressures greater than or equal to 200 psi.

34. A method of manufacturing a composite separator plate for a fuel cell comprising the steps of:
preparing expanded graphite into particles;
dispersing the expanded graphite into a polymeric resin;
compression molding the resin and graphite particles to form the separator plate.

35. A method as set forth in claim 34 wherein the expanded graphite is dispersed by mixing into the polymer resin.

36. A method as set forth in claim 34 wherein the expanded graphite is dispersed by sprinkling into the polymer resin.

37. A method as set forth in claim 34 wherein said expanded graphite comprises between about 10% and about 50% by volume of the plate.

38. A method as set forth in claim 37 wherein the expanded graphite particles are prepared by grinding expanded graphite to particle sizes between about 0.4 and 3.0 mm.

39. A method as set forth in claim 38 wherein said expanded graphite particles are screened.

40. A method as set forth in claim 34 wherein the expanded graphite particles are prepared by grinding the expanded graphite to particle sizes that are greater than 10% of the final plate thickness.

41. A method as set forth in claim 38 wherein said polymeric resin is selected from the group consisting of epoxy, polyvinyl ester, polyester, polypropylene, and polyvinylidene fluoride.

42. A method as set forth in claim 34 further comprising the step of dispersing a filler material in the polymeric resin.

43. A method as set forth in claim 42 wherein said filler material is selected from the group consisting of glass fibers, metal fibers, cotton flock, polyacrylonitrile (PAN) based carbon fibers and polymeric and metallic mesh.

44. A method as set forth in claim 34 further comprising the step of removing a portion of the polymeric resin from at least a portion of one surface of the separator plate.

45. A method as set forth in claim 44 wherein the portion of the polymeric resin is removed by sanding at least a portion of one surface of the separator plate.

46. A method as set forth in claim 34 further comprising the step of disposing a conductive tie layer on at least a portion of the separator plate.

47. A method as set forth in claim 46 wherein said conductive tie layer is vapor deposited on at least a portion of the separator plate.
